(19) United States
(12) Patent Application Publication
(10) Pub. No.: US 2013/0078373 A1
(43) Pub. Date: Mar. 28, 2013

(54) Recycling Cotton Fiber From Old Mattresses

(71) Applicant: Tintoria Piana US, Inc., Cartersville, GA (US)

(72) Inventors: Andrea Piana, Atlanta, GA (US); Sang-hoon Lim, Kennesaw, GA (US)

(73) Assignee: TINTORIA PIANA US, INC., Cartersville, GA (US)

(21) Appl. No.: 13/625,298

(22) Filed: Sep. 24, 2012

Related U.S. Application Data
(60) Provisional application No. 61/538,973, filed on Sep. 26, 2011.

(51) Int. Cl. B05D 5/00

(52) U.S. Cl. 427/212

(57) ABSTRACT

Cotton fibers are reclaimed from old mattresses, particularly from areas of the mattresses which have large amounts of cotton fibers and low amounts of other fibers or binders, and the reclaimed fibers are cleaned and treated with flame retardant chemicals. The reclaimed, flame retardant treated fibers may then be used in new mattresses, furniture and other applications. The reclaimed fibers may be formed into a nonwoven prior to treatment of fire retardant chemicals, and, after the treatment, the nonwoven can function as a fire barrier in mattresses, furniture and in other applications.

### FIELD OF THE INVENTION

The present invention is related to a method to produce flame retardant (FR)-treated cotton using reclaimed cotton from old mattresses. More particularly, the invention contemplates reclaiming cotton fibers from old mattresses, making such fibers fire retardant, and using the FR-treated cotton as fire barrier materials in new products such as new mattresses and furniture.

### BACKGROUND

Recycling old mattresses is a great way to be green and earth-friendly since it can reduce the amount of material sent to landfill. More than 80% of a mattress can be recycled. For example, old mattresses and box-springs can be dismantled into various components, such as steel, foam, wood and cotton. According to ISPA (International Sleep Product Association), there are several ways the old mattress components can be used: Steel can be sold as steel scrap, re-melted, and poured into new steel; polyurethane foam can be collected, mixed with binders, and formed into padding for use underneath wall-to-wall carpets; wood can be chipped up and used as animal bedding, mulch, or as a biomass fuel source; cotton fiber can be reclaimed from old mattresses and mixed with wood fiber and made into matting for use as oil filters in diesel engines.

Hagen, at National Resources Research Institute, University of Minnesota Duluth, proposed value added uses for recycled cotton mattress fiber which included, for example, use for ceiling tiles, a filtration media substrate, a non-woven oil absorbent wiper, a bleached cellulose absorbent, and landscape products.

One of the problems with any “green” or “recycling” program is that the recycling must be achievable in a cost effective manner, and the recycled components must be competitive with non-recycled components in terms of both cost and performance. In recycling old mattresses, the amount of recycling efforts has been somewhat limited despite the relative promise of being readily recyclable. One of the impediments has been an understanding of what components might be readily cost effective for recycling to meet current market demands. Moreover, until this invention, there have been no prior efforts, of which the inventors are aware, to re-use fibers from old mattresses in fire barrier nonwoven materials.

### SUMMARY

According to an embodiment of the invention, cotton fibers are retrieved from a plurality of old mattresses, preferably from locations where cotton fibers are present in an easily retrievable form such as under the ticking and above the insulation pad, and those fibers are cleaned, treated with flame retardant chemicals, and then used as fire barriers in new products such as new mattresses or furniture. In some embodiments, the reclaimed cotton fibers might be formed into a nonwoven, and the nonwoven can then be treated with flame retardant chemicals, and the flame retardant-treated nonwoven can then be used as a fire barrier layer in, for example, a new mattress at a position under the ticking.

### DESCRIPTION OF THE DRAWINGS

FIG. 1 is a schematic drawing of a mattress panel showing an exemplary location for a nonwoven fire barrier containing flame retardant-treated reclaimed cotton fibers.

FIG. 2 shows a schematic drawing of a mattress border showing an exemplary location of the nonwoven fiber barrier according to the present invention.

### DETAILED DESCRIPTION

There has been an increasing demand for flame retardant products for use in mattresses and upholstered furniture. For example, the new U.S. federal open-flame mattress standard (CPSC 16 CFR Part 1633) has created a new demand for flame retardant (FR) fibers in the mattress industry. For the mattress industry, the most cost-effective commonly available FR cellulosic fibers are FR-treated cotton fiber and FR-treated rayon fiber that are produced by post FR chemical treatment on cotton and rayon fibers. Examples of FR-treated cellulosic fibers are commercially available from Tintoria Piana US, Inc. (Cartersville, Ga., USA).

The inventors have identified a process where the utilization of reclaimed cotton from old mattresses will be economical and environmentally-friendly. Recognition of this application and the inventive method is based on the inventors identification of which fibers to collect, and the inventors recognition that new mattresses have to meet a federal open-flame standard (something not required in prior mattresses sold before July, 2007), and that the reclaimed cotton fiber will be a good source for making FR cotton fibers useful in new mattresses and furniture.

After a mattress is used for a period of years, it is often sent to a landfill. While several people have extolled the “recyclability” of mattresses, recycling efforts have lagged because of the difficulty in recovering valuable materials for re-use. This invention is particularly related to the recovery and re-use of cotton fibers which are used in mattresses.

Mattresses contain a variety of fibers including cotton fibers, synthetic fibers, and rayon fibers. Synthetic fibers are not of interest in this invention and are preferably separated when the cotton fibers are recovered. However, the reclaimed cotton may contain some amount of synthetic fibers which are not completely separated from cotton during the reclamation process. Preferably, the reclaimed cotton will contain less than 20%, and more particularly less than 10%, 5%, 4%, 3%, 2%, or 1% by weight synthetic fibers. The reclaimed cotton from the mattresses can be sorted and graded based on the amount of synthetics fibers in the cotton. Rayon is typically used for the nonwoven material in mattresses, and the nonwoven is positioned right under the ticking fabric. The nonwoven is often bonded with binder fiber, and, therefore, cannot easily be used in a reclaiming process as contemplated herein.

There are several layers and types of cotton in a mattress. The layer just above the steel coils in a mattress is called the “insulation pad”. This pad functions as a protective barrier between the steel coils and loftier cotton batting above it. The insulation pad is a nonwoven mat composed mainly synthetics and a small amount of cotton bonded together with binder fiber. Thus, the insulation pad is not of particular interest for use in the present invention. By contrast, the loftier cotton batting above the insulation pad is a very good source of cotton to recycle. The cotton batting is made generally of low quality cotton (e.g., first-cut-cotton-linters, which is a byproduct from the cotton seed oil industry). This cotton batting is easily pulled from mattresses since it is generally not bonded with binder fiber. It will be recognized, however, reclaimed cotton can be obtained from a variety of different areas of a mattress, and that different mattresses will have suitable cotton fibers at different locations. Typically, all that is required is that the reclaimed cotton come from sections of the mattress where a majority of the fibers are cotton, e.g., it is preferred that the cotton come from sections where 80%, or more preferably, 90%, 95%, 96%, 97%, 98%, 99% or even 100% by weight is cotton, and it is preferred that the sections of the mattress where the cotton is reclaimed include either no binder or less than 20% or 10% by weight binder.

The reclaimed cotton fiber from old mattresses needs to undergo a cleaning (scouring and/or bleaching) procedure. This can be done using a continuous bleaching range or using a package or stock dyeing machine. The purpose of scouring and/or bleaching is to clean the dirt and impurities from the cotton (e.g., dirt which penetrates into a mattress from external sources, fragments of dirt which adhered to the low quality cotton prior to its use in the bedding, and natural impurities on cotton such as wax, pectin, and so on). It will be recognized that reclaimed cotton from old mattresses should be cleaned well before the FR treatment since post-consumer recycled cotton is dirty and contaminated. The scouring and/or bleaching procedures permit removal of the unwanted dirt from the reclaimed cotton fibers and leaves the cotton fibers predominantly white and cleaned state. In addition, the scouring and/or bleaching can remove biological contaminants such as mites and microbes.

Scouring refers to the removal of impurities by a wet treatment. Generally, cotton is heated in water to 160˜260° F. for a desired time (normally 30˜60 minutes) together with scouring auxiliary chemicals and/or alkali. Bleaching is a step to remove impurities and makes cotton white by decolorizing the impurities that mask the natural whiteness of the fiber. Generally, bleaching is done by heating cotton in water to 180˜260° F. for a desired time (normally 30˜60 minutes) together with bleaching auxiliary chemicals, hydrogen peroxide, and caustic soda. Another important aspect of the bleaching step is to sanitize the post-consumer cotton fibers. The cleanness of the bleached cotton can be evaluated by a microbiological test, such as DIN 54379, which determines total colony forming count (CFU) on a dry matter. There is no microbiological regulation on post-consumer cotton fiber, but for paper products to be used for containers for food products, the recommendation by the International Dairy Federation is a maximum 250 CFU per gram of a dry matter. It is preferred that the sanitization performed during cleaning of the reclaimed cotton fibers from the mattresses be performed so as to have a maximum of 250 CFU per gram of dry matter similar to the recycled paper standards.

In order to use the reclaimed and cleaned cotton fibers in new mattresses or furniture, e.g., as batting or as part of a nonwoven product such as an FR cotton and FR rayon nonwoven blend which is bonded with binder fiber, chemically bonded, or mechanically bonded, after scouring and/or bleaching to clean the cotton, the cleaned cotton is further treated with FR chemicals by, for example, the methods described by US Pat. Nos. 7,211,293 and 7,736,696, both of which are herein incorporated by reference. That is, the reclaimed cotton fibers can be positioned in a stock dyeing machine or other vessel, and a liquid mixture of FR chemicals can be circulated through the fibers. To aid in the environmentally friendly nature of the process, the FR chemicals which do not impregnate the fibers can be recovered and recycled, and, if required, additional FR chemicals can be added when subsequent batches of fibers are exposed to the FR chemicals. Other methods to apply FR chemicals to the cleaned cotton can be used and include, but are not limited to, mixing, spraying, and impregnation methods. For an exemplary mixing method, finely ground FR compound is mixed with the fiber in a mixing machine. A small amount of oil and surfactant are added to control dust and improve bonding of FR compound on the fiber. For an exemplary spraying method, a desired amount of FR chemical solution is sprayed on the fiber and the fiber is dried. For an exemplary impregnation method, the fiber is soaked in FR chemical solution, the excess amount of FR chemical solution is removed, and then the fiber is dried.

Flame retardant substances which may be employed in the practice of the invention include virtually any flame retardant substance, such as the chemical compounds described below, or combinations of one or more flame retardant substances, that has the ability to provide one or more flame retardant properties to the reclaimed and cleaned cotton fibers. Certain flame retardant substances may exhibit an enhanced performance with particular substrates. Factors such as the quantity, type and physical and chemical nature of the reclaimed cotton fibers being treated (porosity of surfaces, hydrophilic nature and like characteristics), the chemical nature of the flame retardant substances, the viscosity and surface tension of the aqueous or non-aqueous fluid medium, the amount and nature of other components that are present in the flame retardant compositions, the application method being employed, the function that the final product should perform and like considerations may influence the performance of a particular flame retardant substance with a particular substrate. However, those of skill in the art may readily determine the flame retardant substances that should achieve a desired performance or result in connection with the reclaimed cotton fibers.

Exemplary flame retardants that may include any of those discussed below, or combinations of those which are discussed below. FR chemicals for the FR treatments include, but are not limited to, phosphorus-containing FR chemicals, sulfur-containing FR chemicals, halogen-containing FR chemicals, antimony-containing FR chemicals, and boron-containing FR chemicals. Examples of FR chemicals include, but are not limited to, phosphoric acid and its derivatives, phosphonic acid and its derivatives, sulfuric acid and its derivatives, sulfamic acid and its derivatives, boric acid and its derivatives, borax, borates, ammonium phosphates, ammonium polyphosphates, ammonium sulfate, ammonium sulfamate, ammonium chloride, and ammonium bromide. Extensive examples of commercially available FR chemicals are known to those of skill in the art and can be found in Kirk-Othmer Encyclopedia of Chemical Technology (Wiley, New York, 1994, 4th edition)

To make fire barrier nonwoven, the FR-treated reclaimed cotton can be used alone or it can be blended with any other desired fibers (either FR or non-FR fibers). The nonwoven may be made using mechanical bonding, chemical bonding, or thermal bonding techniques. In an exemplary embodiment, thermal bonding using low melting point binder fiber is employed to manufacture nonwoven products.

As an alternative method of the FR treatment described above, the reclaimed and cleaned cotton is made into a nonwoven by blending with other required fibers and then FR chemicals can be applied on the nonwoven to produce FR barrier nonwoven. Exemplary FR chemical application methods for the nonwoven include, but are not limited to, padding, spraying, kiss roll application, foam application, blade application, and vacuum extraction application. After a desired amount of FR chemical formulation is applied on the nonwoven by these methods, the nonwovens are dried. For example, in the padding method, the nonwoven is immersed in FR chemical solution, the amount of FR chemical on the nonwoven is controlled by adjusting pressure of the padder rolls, and then the nonwoven is dried in an oven.

Some of the reclaimed fibers from mattresses could be FR-treated cotton; however, for older mattresses, the cotton will typically not be FR-treated cotton. Although the reclaimed cotton fibers may contain FR chemicals, those will be removed during the cleaning step. The cleaning step is important for ensuring the following FR treatment. Regardless of the nature of the cotton (FR or non-FR), the invention contemplates FR treatment of the reclaimed and cleaned cotton fibers so as to guarantee that the fibers produced meet flammability standards.

The FR-treated cotton fiber produced by this method can be utilized in any applications that require FR-treated cotton and are preferably made into nonwoven fire barrier by blending with other required fibers to be used in new mattresses and furniture (chairs, sofas, etc.).

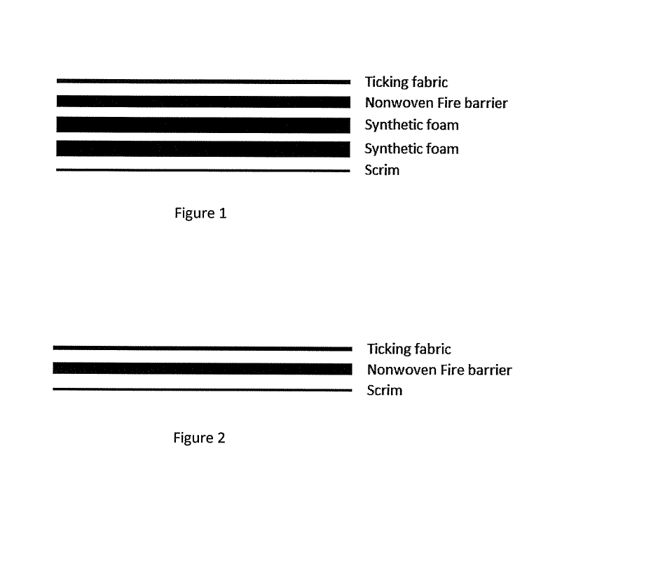

FIG. 1 shows that the fire barrier nonwoven made according to the present invention have particular application in mattress panels (the top part of the mattress). In these panels, the scrim, foam, and nonwoven barrier layers are stitched together with the ticking fabric. The nonwoven fire barrier layer just under the ticking can contain FR-treated reclaimed cotton fibers from old mattresses according to the present invention (which can be constructed together with other fibers including without limitation rayon fibers, synthetic fibers, and/or untreated cotton fibers), and will be suitable for meeting safety requirements for new mattresses. FIG. 2 shows a typical structure of mattress and mattress foundation borders (the side parts of mattress and mattress foundation). A nonwoven fire barrier and/or flame retardant cotton fibers made according to the present invention can be used in the border construction of mattresses.

### Example 1

Reclaimed cotton fiber (2000 lbs) from old mattress was scoured and bleached using a commercial stock dyeing machine. Scouring was done at 208° F. for 30 min in the presence of scouring auxiliary chemicals and alkali and then beaching is done at 208° F. for 60 min in the presence of bleaching auxiliary chemicals, hydrogen peroxide, and caustic soda.

The bleached cotton fiber sample was sent to an independent laboratory for a microbiological test (DIN 54279). The test result showed that the colony forming units (CFU) for 1 gram of the dried bleached cotton fiber was less than 100. (International Dairy Federation recommends maximum 250 CFU/g for paper fibers to be used for containers for food products). Based on the test result, it was demonstrated that bleaching process cleaned the recycled cotton enough to be used for new mattresses or furniture.

The bleached cotton fiber was treated with a flame retardant chemical (ammonium sulfate based) using a commercial stock dyeing machine according to the method described by U.S. Pat. Nos. 7,211,293 and 7,736,696.

The FR-treated cotton fiber was blended with other fibers, such as FR-treated rayon fiber and binder fiber to be made into nonwoven fire barrier. Thermal bonded high-loft nonwoven samples were prepared by using a commercial production line. The blended fibers were carded to form a fiber web on a conveyor. The web is cross-lapped and passed through an oven to form a thermal-bonded high-loft nonwoven. An examplary high-loft nonwoven fire barrier containing the FR-treated cotton was prepared using reclaimed cotton from an old mattress (FR-treated reclaimed cotton:FR-treated rayon:binder fiber=40:40:20). The blending composition of the FR cotton fiber with other fibers and its basis weight are decided by final use of the nonwoven fire barrier.

1. A method of recycling cotton fibers, comprising the steps of:
reclaiming cotton fibers from a plurality of mattresses to yield reclaimed fibers;
cleaning the reclaimed fibers to produce cleaned fibers;
treating the cleaned fibers with one or more flame retardant chemicals to produce flame retardant treated cotton fibers; and
using the flame retardant treated cotton fibers in one or more new products.

2. The method of claim 1 wherein said reclaiming step is performed by obtaining said cotton fibers from cotton batting positioned above an insulation pad and below ticking fabric in each of said plurality of mattresses.

3. The method of claim 1 wherein said reclaiming step includes separating synthetic fibers from cotton fibers and recovering cotton fibers which contain less than 20% by weight synthetic fibers.

4. The method of claim 1 wherein said reclaiming step is performed by obtaining cotton fibers only from sections of each mattress which include at least 80% by weight cotton and less than 10% by weight binder.

5. The method of claim 1 wherein said cleaning step is performed by scouring said re-claimed fibers.

6. The method of claim 1 wherein said cleaning step is performed by bleaching said reclaimed fibers.

7. The method of claim 1 wherein said cleaning step is performed under conditions sufficient to sanitize said reclaimed fibers.

8. The method of claim 1 wherein said one or more new products are selected from mattresses or furniture.

9. The method of claim 1 wherein said one or more new products includes a mattress panel, and wherein said flame retardant treated cotton fibers are included in a nonwoven fire barrier which is positioned under ticking of said mattress panel.

10. The method of claim 9 wherein said nonwoven fire barrier includes fibers other than said flame retardant treated cotton fibers.

11. The method of claim 1 wherein said one or more new products includes a mattress border, and wherein said flame retardant treated cotton fibers are positioned under ticking of said mattress border.

12. The method of claim 1 wherein said one or more new products are selected as being products which require flame retardant treated cotton.

13. The method of claim 1 wherein the one or more flame retardant chemicals are selected from the group consisting of phosphorus-containing FR chemicals, sulfur-containing FR chemicals, halogen-containing FR chemicals, antimony-containing FR chemicals, and boron-containing FR chemicals.

14. The method of claim 1 further comprising the step of making a nonwoven from the cleaned fibers prior to said treating step, and wherein said treating step includes applying said one or more flame retardant chemicals to said nonwoven.
